(19) United States
(12) Patent Application Publication
(10) Pub. No.: US 2014/0379778 A1
(43) Pub. Date: Dec. 25, 2014

(54) ASYNCHRONOUS TRANSPORT SETUP AND SELECTION FOR INTERACTIVE APPLICATIONS

(71) Applicant: Microsoft Corporation, Redmond, WA (US)

(72) Inventors: Rajneesh Mahajan, Woodinville, WA (US); Harold Zhaohui Zhu, Sammamish, WA (US); Siddharth Ramakrishnan, Bellevue, WA (US); Somesh Goel, Newcastle, WA (US)

(21) Appl. No.: 13/923,134

(22) Filed: Jun. 20, 2013

(51) Int. Cl. H04L 29/08

(52) U.S. Cl. CPC H04L 67/10
USPC 709/203

(57) ABSTRACT

Embodiments are directed to dynamically switching data transports and to dynamically managing data transports within a communication session. In one scenario, a client computer system establishes a first connection to a server computer system and receives data over that connection using one type of data transport. The client computer system then establishes another connection to the server using a second, different data transport while the first connection is being used to transfer data between the client and the server. The client computer system next receives an indication that the second connection using the second data transport has been established, and synchronizes the client and the server, so that subsequent client-server communication occurs on the second connection using the second data transport. The client then receives data from the server computer system over the second connection using the second data transport.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications are designed to interact with other software applications or other computer systems. These interactions may be conducted using different data transports. For example, network transfer of interactive content may include setup of multiple transports between two communicating parties. For instance, when using the remote desktop protocol (RDP), a transmission control protocol (TCP) transport is setup for non-interactive control information, and various user datagram protocol (UDP) transports are setup for interactive content such as graphics, audio and video.

### BRIEF SUMMARY

Embodiments described herein are directed to dynamically switching data transports and to dynamically managing data transports within a communication session. In one embodiment, a client computer system establishes a first connection to a server computer system using a first data transport and receives data over the first connection using the first data transport. The client computer system then establishes a second connection to the server computer system using a second, different data transport while the first connection is being used to transfer data between the client computer system and the server computer system. The client computer system next receives an indication that the second connection using the second data transport has been established, and synchronizes the client computer system and the server computer system, so that subsequent client-server communication occurs on the second connection using the second data transport. The client computer system then receives data from the server computer system over the second connection using the second data transport.

In another embodiment, a client computer system determines that a first connection to a server computer system has been established using a first data transport. The client computer system next analyzes various factors to determine whether the first connection using the first data transport is to be transitioned to a second connection using a second, different data transport. Upon determining, based on the factors, that the first connection is to be transitioned to the second connection, the client computer system establishes a second connection to the server computer system using a second, different data transport while the first connection is being used to transfer data between the client computer system and the server computer system. The client computer system then receives an indication that the second connection using the second data transport has been established and synchronizes the client computer system and the server computer system, so that subsequent client-server communication occurs on the second connection using the second data transport. The client computer system further receives data from the server computer system over the second connection using the second data transport.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including dynamically switching data transports.

FIG. 2 illustrates a flowchart of an example method for dynamically switching data transports.

FIG. 3 illustrates a flowchart of an example method for dynamically managing data transports within a communication session.

FIG. 4A illustrates an embodiment in which a soft synchronization is performed.

FIG. 4B illustrates an embodiment in which a hard synchronization is performed.

### DETAILED DESCRIPTION

Embodiments described herein are directed to dynamically switching data transports and to dynamically managing data transports within a communication session. In one embodiment, a client computer system establishes a first connection to a server computer system using a first data transport and receives data over the first connection using the first data transport. The client computer system then establishes a second connection to the server computer system using a second, different data transport while the first connection is being used to transfer data between the client computer system and the server computer system. The client computer system next receives an indication that the second connection using the second data transport has been established, and synchronizes the client computer system and the server computer system, so that subsequent client-server communication occurs on the second connection using the second data transport. The client computer system then receives data from the server computer system over the second connection using the second data transport.

In another embodiment, a client computer system determines that a first connection to a server computer system has been established using a first data transport. The client computer system next analyzes various factors to determine whether the first connection using the first data transport is to be transitioned to a second connection using a second, different data transport. Upon determining, based on the factors, that the first connection is to be transitioned to the second connection, the client computer system establishes a second connection to the server computer system using a second, different data transport while the first connection is being used to transfer data between the client computer system and the server computer system. The client computer system then receives an indication that the second connection using the second data transport has been established and synchronizes the client computer system and the server computer system, so that subsequent client-server communication occurs on the second connection using the second data transport. The client computer system further receives data from the server computer system over the second connection using the second data transport.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments described herein can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that various embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments described herein may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

Additionally or alternatively, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and other types of programmable hardware.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

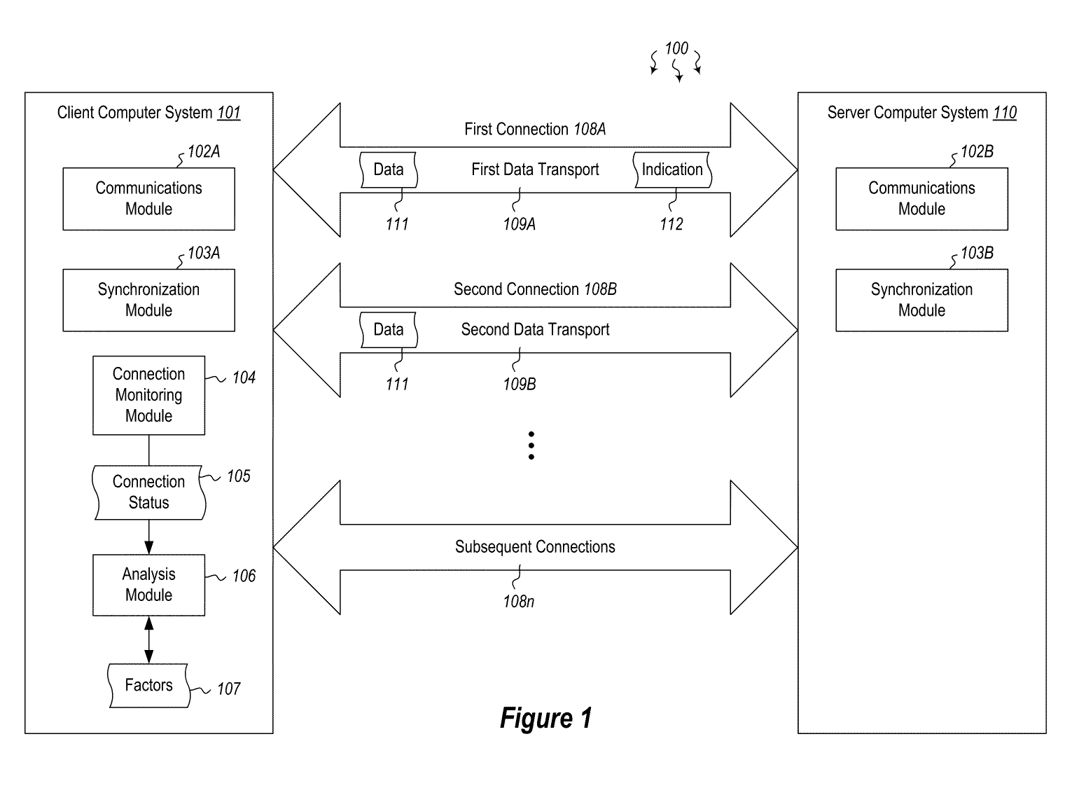

FIG. 1 illustrates a computer architecture 100 in which at least one embodiment may be employed. Computer architecture 100 includes client computer system 101 and server computer system 110. Both the client computer system 101 and the server computer system 110 may be any type of local or distributed computer system, including a cloud computing system. Each of the computer systems includes modules for performing a variety of different functions. For instance, the client computer system 101 includes a communications module 102A. The communications module 102 may be used to communicate with other computer systems, including server computer system 110. The server 110 also has a communications module 102B for sending and receiving data 111. The data may be any type of data, including audio, video, text, images or other types of data.

Both the client computer system 101 and the server computer system 110 include synchronization modules 103A and 103B, respectively. The synchronization modules may be used to synchronize data transfers between the client 101 and the server 110, or between other computer systems (not shown in FIG. 1). Still further, the client computer system may include a connection monitoring module 104 that is configured to monitor any of the established connections 108A, 108B or other connections 108N. These connections may be established and kept alive for an indeterminate amount of time. The connection monitoring module 104 may monitor any of the live connections to determine various aspects of the data transfer, and determine if the data might be more optimally transferred using a different data transport. As used herein, a “data transport” refers to any communication protocol, transfer method or other means of transporting data between computing systems. In some cases, the first and second connections 108A and 108B may use the same data transports, or they may use different data transports, such as first and second data transports 109A and 109B.

In some embodiments, a data transfer may begin (e.g. from the server 110 to the client 101) using one data transport and later switch to another data transport. Thus, data content streams may be initiated using first data transport 109A and then dynamically switched to the second (or another) data transport 109B whenever the second data transport is ready for use. This may allow a user to receive data substantially immediately using the first data transport, and then have the data transfer switched to a more optimal data transport at a subsequent time.

In one example, a user may be using remote desktop protocol (RDP) to receive and view a remote desktop on the client computer system 101. The server computer system 110 may send graphics, audio and or video data on, for example, a transmission control protocol (TCP) transport as soon as the connection is ready. Subsequently, when a, for example, user datagram protocol (UDP) transport is ready, it may be used to transfer graphics or other data (including streaming content). When the UDP transport used for audio and video becomes ready at a later point in time, a similar switch may be performed for those streams from TCP to their UDP transport. It should be understood that while specific protocols may be called out in example embodiments herein, the principles described herein apply when using substantially any protocol or other data transport.

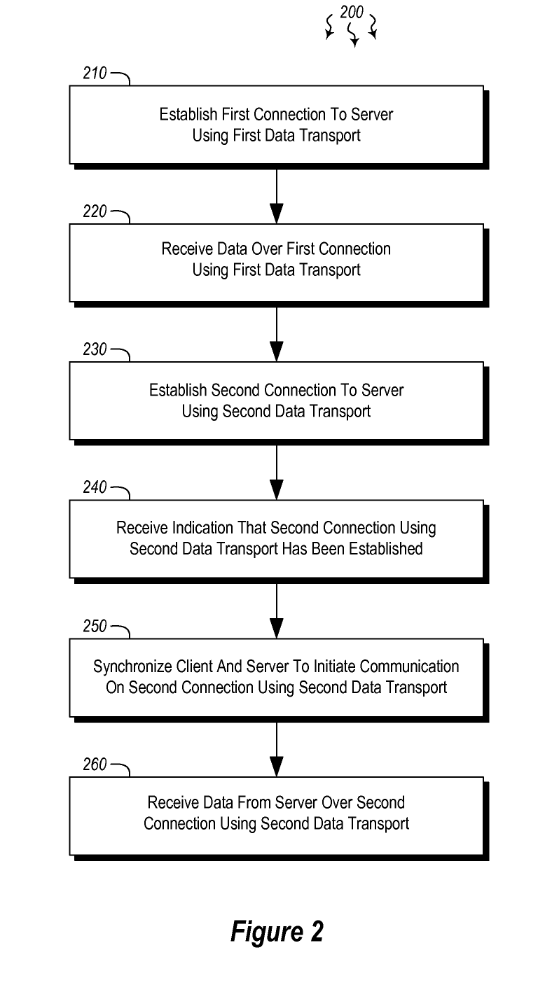

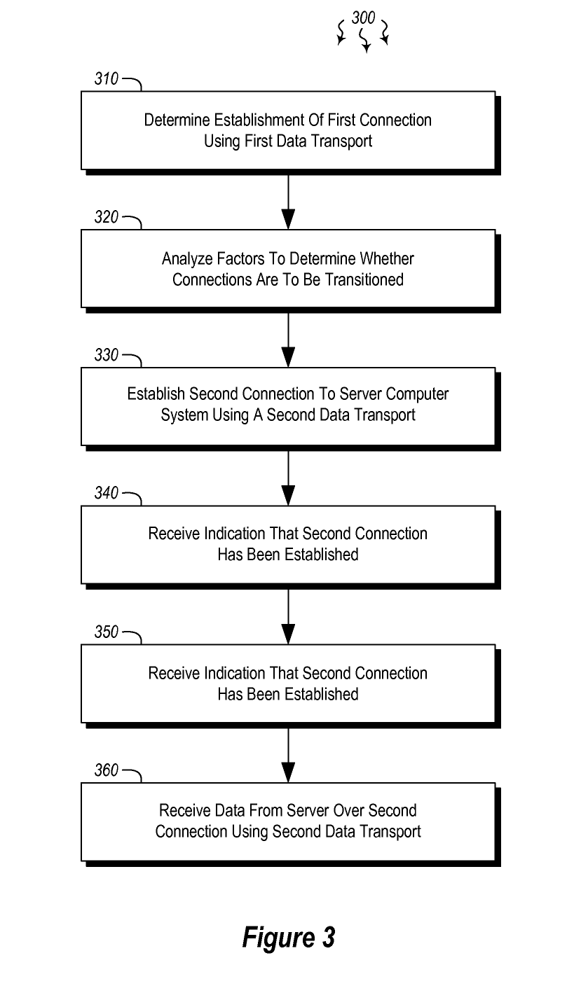

Creation and/or removal of a data transport may be performed at substantially any time. For instance, if the first connection 108A were no longer needed, it may be removed. If additional connections (108n) were needed, they may be instantiated between the client 101 and server 110. Information related to current connections may be monitored by connection monitoring module 104, and may be relayed between the client 101 and server 110 using a master transport which is always available. In this manner, the embodiments described herein allow a data stream to be initialized on one transport and then switched to another transport substantially without interruption. Moreover, embodiments described herein allow new transport streams to be added or removed dynamically, and allow switching, creating or removing connections to occur at any time during connection flow. These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for dynamically switching data transports. The method 200 will now be described with frequent reference to the components and data of environment 100.

Method 200 includes an act of establishing a first connection to a server computer system using a first data transport (act 210). For example, the communications module 102A of client computer system 101 may establish first connection 108A to server computer system 110. The data 111 may be transferred between the client 101 and server 110 using first data transport 109A. This first data transport may be TCP, UDP, IP or some other transport. The first connection 108A may be established and/or removed at substantially any time. In some cases, the first connection 108A is used to transfer data initially, while another connection is being established. During this time, data is received over the first connection 108A using the first data transport 109A (act 220). As mentioned above, this data 111 may be audio, video, text, images, web pages, documents or any other type of data.

Method 200 also includes an act of establishing a second connection to the server computer system using a second, different data transport while the first connection is being used to transfer data between the client computer system and the server computer system (act 230). Thus, for example, the communications module 102A of client computer system 101 may establish second connection 108B with the communications module 102B of the server 110. This second connection may be established while data is being transmitted over the first connection 108A. Thus, in cases where a user is using an application provided by the server 110 (such as a remote desktop), the server may begin providing that application using a quickly established connection, so as to provide the user with a faster startup time. Then, if another type of data transport is better suited to transferring data for that application, the data transfer may be switched from the first connection 108A to the second connection 108B.

In some embodiments, the first data transport 109A is TCP, and the second data transport 109B is UDP. The first connection 108A may implement TCP to transfer user credentials, for example, to the server computer system 110. The first connection (using TCP, for example) may also be implemented to transfer remote desktop data including graphics data, audio data and/or video data. This first connection may be used to create a responsive user experience, such that when the user initiates an application, that application loads quickly, and is available to the user as soon as possible over the first connection 108A. The second connection 108B may also be established between the client 101 and the server 110 during the data transfer over the first connection. The second connection may implement UDP, for example, to transfer remote desktop data including graphics data, audio data and/or video data. As UDP is better suited to transferring these types of data than TCP (at least in some cases), the data transfer initiated over the first connection 108A may be transitioned to the second connection 108B for subsequent data transfer. This transition, it should be noted, may occur during the remote desktop session, while the session is live (i.e. when the client is actually using the TCP (or other) transport).

Method 200 further includes an act of receiving an indication that the second connection using the second data transport has been established (act 240). For example, the communications module 102B of the server computing system 110 may send an indication 112 that the second data transport 109B has been established. This indication may be received at the client 101, which may then use the synchronization module 103A to synchronize the client computer system 101 and the server computer system 110, such that subsequent client-server communication occurs on the second connection using the second data transport 109B (act 250).

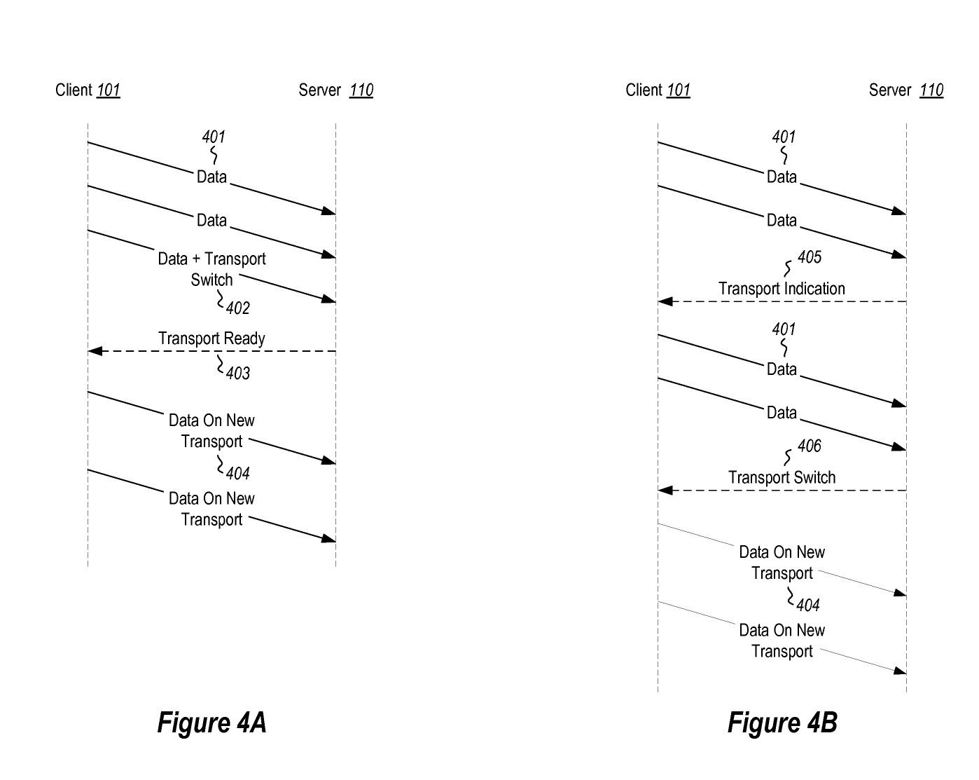

The synchronization module 103A may communicate with the synchronization module 103B of the server 110 to ensure that the client and server are in synch before the data transfer is transferred from the first connection 108A to the second connection 108B. The synchronization may occur in different ways, including hard synchronizations and soft synchronizations, as shown in FIGS. 4A and 4B. In a hard synchronization (as shown in FIG. 4A), data 401 is transferred from client 101 to server 110 using the first data transport 109A. The client then sends to the server a transport switch 402 along with the data. The transport switch indicates that the data transfer should be switched from the first connection 108A to the second connection 108B. The server sends a “transport ready” notification 403 indicating that the server will be sending subsequent data communications over the second connection 108B, using the second data transport 109B. Subsequent data is then transferred using the new transport 404 (i.e. second transport 109B). Thus, in a hard synchronization, the client and server agree that data is not to be transferred using the second transport until the server indicates that data is to be transferred.

In a soft synchronization, a first indication 405 is sent from the server computer system 110 indicating that the server intends to begin transferring data 401 using the second data transport 109B. Data continues to be transferred over the first data transport 109A until the server sends a transport switch message 406 to the client (opposite from a hard synch), indicating that the server has initiated data transfer using the second data transport 109B. Accordingly, in a soft synchronization, the server indicates to the client that the server will soon begin transferring data over the new data transport (e.g. 109B), and then sends a notification 406 that subsequent packets will be sent on the new transport.

Returning to FIG. 2, method 200 includes an act of receiving one or more portions of data from the server computer system over the second connection using the second data transport (act 260). Thus, data 111 may be received from the server 110 using the second connection 108B and the second data transport 109B. In some cases, it may be determined (by either the client or the server) that the data transfer should be switched back to the first connection, or to another connection (e.g. 108N). The data connection may then be switched back to the first connection, or to the other connection for subsequent data transfer. In cases where the server 110 is providing a remote desktop session to a user, the server may switch between the first connection 108A and the second connection 108B dynamically during the remote desktop session. The server may switch connections based on a determination of which connection is currently optimal. For example, the connection monitoring module 104 may monitor the connections to determine a connection status 105 for each connection. Then, using this information, the client 101 may indicate to the server 110 which data transport is currently the best for sending a certain type of data. Connection conditions may change, for example, based on the time of day, amount of available bandwidth, latency, router load or other factors.

Once a decision has been made to transition from the first transport 108A to the second transport 108B (or from the second transport to the first, or to another transport), the transition between transports is substantially seamless to where the transition is more or less imperceptible to a user. The client 101 and server 110 may synchronize with each other before each transition, to ensure that each system is aware of which data transport will be used at any given moment. In this manner, the client and server may switch between substantially any number of different data transports within a single user session. New connections may be added and old connections may be removed as needed, and as agreed to by the server and client computer systems. This will be explained further below with regard to FIG. 3.

FIG. 3 illustrates a flowchart of a method 300 for dynamically managing data transports within a communication session. The method 300 will now be described with frequent reference to the components and data of environment 100.

Method 300 includes an act of determining that a first connection to a server computer system has been established using a first data transport (act 310). For example, first connection 108A may be established between client computer system 101 and server computer system 110. The first connection 108A may use first data transport 109A, which may be any type of data transport.

Method 300 next includes an act of analyzing one or more factors to determine whether the first connection using the first data transport is to be transitioned to a second connection using a second, different data transport (act 320). The analysis module 106 of the client computer system 101 may analyze various connection factors 107 (including available bandwidth, latency, router status, pricing, time of day, etc.) to determine whether another data transport would be better suited to transfer the data. Then, upon determining, based on the one or more factors, that the first connection 108A is to be transitioned to the second connection 108B, the communications module 102A of the client 101 may establish a second connection 108B to the server 110 using a second, different data transport 109B while the first connection is being used to transfer data between the client computer system and the server computer system (act 330). The transition to the second connection and second transport is seamlessly performed in the background, so that users using applications provided by the server 110 are unaware that a transition took place. As noted above, this transition to the second transport may occur during a remote desktop (or other authenticated) session, while the session is alive and the client is still using the first data transport.

Method 300 further includes an act of receiving an indication 112 that the second connection using the second data transport has been established (act 340). The synchronization module 103A then synchronizes the client computer system 101 and the server computer system 110 (using either a hard or a soft synch), such that subsequent client-server communication occurs on the second connection 108B using the second data transport 109B (act 350). After the computing systems are synchronized, the client computer system can receive data from the server computer system over the second connection 108B using the second data transport 109B (act 360). It should be understood that while the above embodiment has been described from the perspective of the client computer system, at least in some embodiments, the analysis module 106 may be part of the server 110, and the server may determine that the data transfer is to be moved (based on one or more factors 107) to another connection.

In some cases, the analysis module 106 may subsequently determine, based on the one or more factors 107, that the second connection 108B is to be transitioned back to the first connection 108A. At this point, the synchronization module 103A may synchronize the client computer system 101 and the server computer system 110 using a hard or a soft synch. As such, subsequent client-server communication occurs on the first connection 108A using the first data transport 109A, and the client 101 receives data 111 over the first connection using the first data transport.

The analysis module 106 may also determine, based on the factors 107, that a third connection (e.g. 108N) is to be established. The communications module 102A may establish the third connection using the first data transport 109A, the second data transport 109B, or a third, different data transport. The analysis module 106 may determine that the first connection or the second connection is to be transitioned to the third connection using a third, different data transport. In such cases, the synchronization module 103A will synchronize the client 101 and the server 110. As such, subsequent client-server communication will occur on the third connection using the third data transport, and data 111 will be received at the client 101 over the third connection using the third data transport.

Still further, the analysis module 106 may determine, based any of the factors 107, that at least one of the data connections (108A-N) is to be removed. The communications module 102A may then remove the determined data connections. Once removed, the determined data connection is no longer used to transfer data between the client 101 and server 110. In this manner, connections using various different data transports may be established and removed dynamically, as needed and as determined appropriate by the analysis module. Still further, it should be noted that various components of the client computer system 101 (including any of modules 102A, 103A, 104 and 106, or any hardware components such as graphics cards, network cards, audio cards or other components) may have their own virtual channels. These virtual channels may be multiplexed together to create a remote desktop session for a user. Within this remote desktop session, data transfers may be dynamically switched between different connections to provide the user the most responsive and usable experience possible.

Accordingly, methods, systems and computer program products are provided which dynamically switch between data transports when transferring data between computer systems. Moreover, methods, systems and computer program products are provided which dynamically manage data transports within a communication session, including adding or removing connections as needed.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. A client computer system comprising the following:
one or more processors;
system memory;
one or more computer-readable storage media having stored thereon computer-executable instructions that, when executed by the one or more processors, causes the computing system to perform a method for dynamically switching data transports, the method comprising the following:
an act of establishing a first connection to a server computer system using a first data transport;
an act of receiving one or more portions of data over the first connection using the first data transport;
an act of establishing a second connection to the server computer system using a second, different data transport while the first connection is being used to transfer data between the client computer system and the server computer system;
an act of receiving an indication that the second connection using the second data transport has been established;
an act of synchronizing the client computer system and the server computer system, such that subsequent client-server communication occurs on the second connection using the second data transport; and
an act of receiving one or more portions of data from the server computer system over the second connection using the second data transport.

2. The client computer system of claim 1, wherein a hard synchronization is performed between the client computer system and the server computer system, the hard synchronization specifying that data is not to be transferred using the second transport until the server indicates that data is to be transferred.

3. The client computer system of claim 1, wherein a soft synchronization is performed between the client computer system and the server computer system, the soft synchronization including a first indication from the server computer system that the server computer system intends to begin transferring data using the second data transport and a second, subsequent indication from the server computer system indicating that the server computer system has initiated data transfer using the second data transport.

4. The client computer system of claim 1, wherein the first data transport comprises the transmission control protocol (TCP), and the second data transport comprises the user datagram protocol (UDP).

5. The client computer system of claim 4, wherein the first connection implements TCP to transfer user credentials to the server computer system.

6. The client computer system of claim 4, wherein the first connection implements TCP to transfer remote desktop data including at least one of: graphics data, audio data and video data.

7. The client computer system of claim 4, wherein the second connection implements UDP to transfer remote desktop data including at least one of: graphics data, audio data and video data.

8. The client computer system of claim 1, further comprising an act of switching between the first connection and the second connection dynamically during a remote desktop session.

9. The client computer system of claim 8, wherein data transfer is switched between the first and second connections in response to a determination that the second connection is better suited to transferring data under current conditions.

10. The client computer system of claim 1, wherein the transition from the first transport to the second transport is substantially seamless, such that the transition is imperceptible to a user.

11. The client computer system of claim 1, further comprising switching from the second connection to a third connection, using a third data transport that is different from the first and second data transports.

12. A client computer system comprising the following:
one or more processors;
system memory;
one or more computer-readable storage media having stored thereon computer-executable instructions that, when executed by the one or more processors, causes the computing system to perform a method for dynamically managing data transports within a communication session, the method comprising the following:
an act of determining that a first connection to a server computer system has been established using a first data transport;
an act of analyzing one or more factors to determine whether the first connection using the first data transport is to be transitioned to a second connection using a second, different data transport;
upon determining, based on the one or more factors, that the first connection is to be transitioned to the second connection, an act of establishing a second connection to the server computer system using a second, different data transport while the first connection is being used to transfer data between the client computer system and the server computer system;
an act of receiving an indication that the second connection using the second data transport has been established;
an act of synchronizing the client computer system and the server computer system, such that subsequent client-server communication is to occur on the second connection using the second data transport; and
an act of receiving one or more portions of data from the server computer system over the second connection using the second data transport.

13. The client computer system of claim 12, wherein the factors for determining when to transition between connections comprise at least one of the following: data transfer performance, pricing and time of day.

14. The client computer system of claim 12, further comprising:
an act of determining, based on the one or more factors, that the second connection is to be transitioned back to the first connection;
an act of synchronizing the client computer system and the server computer system, such that subsequent client-server communication is to occur on the first connection using the first data transport; and
an act of receiving one or more portions of data from the server computer system over the first connection using the first data transport.

15. The client computer system of claim 12, further comprising:
an act of determining, based on the one or more factors, that a third connection is to be established; and
an act of establishing the third connection using a third, different data transport.

16. The client computer system of claim 15, further comprising:
an act of determining, based on the one or more factors, that that the second connection is to be transitioned to the third connection using the third data transport;
an act of synchronizing the client computer system and the server computer system, such that subsequent client-server communication is to occur on the third connection using the third data transport; and
an act of receiving one or more portions of data from the server computer system over the third connection using the third data transport.

17. The client computer system of claim 12, further comprising:
an act of determining, based on the one or more factors, that at least one of the data connections is to be removed; and
an act of removing the determined data connections, such that the determined data connection is no longer used to transfer data between the client computer system and the server computer system.

18. The client computer system of claim 12, wherein one or more client computer system components have their own virtual channels.

19. The client computer system of claim 12, wherein the virtual channels are multiplexed together to create a remote desktop session.

20. A computer system comprising the following:
one or more processors;
system memory;
one or more computer-readable storage media having stored thereon computer-executable instructions that, when executed by the one or more processors, causes the computing system to perform a method for dynamically managing data transports within a communication session, the method comprising the following:
an act of determining that a first connection to a server computer system has been established using a first data transport;
an act of analyzing one or more factors to determine whether the first connection using the first data transport is to be transitioned to a second connection using a second, different data transport;
upon determining, based on the one or more factors, that the first connection is to be transitioned to the second connection, an act of establishing a second connection to the server computer system using a second, different data transport while the first connection is being used to transfer data between the client computer system and the server computer system;
an act of receiving indication that the second connection using the second data transport has been established;
an act of synchronizing the client computer system and the server computer system, such that subsequent client-server communication is to occur on the second connection using the second data transport;
an act of receiving one or more portions of data from the server computer system over the second connection using the second data transport;
an act of determining, based on the one or more factors, that a third connection is to be established;
an act of establishing the third connection using a third, different data transport.
an act of determining, based on the one or more factors, that that the second connection is to be transitioned to the third connection using the third data transport;
an act of synchronizing the client computer system and the server computer system, such that subsequent client-server communication is to occur on the third connection using the third data transport; and
an act of receiving one or more portions of data from the server computer system over the third connection using the third data transport.
